(19) United States
(12) Patent Application Publication
(10) Pub. No.: US 2013/0099731 A1
(43) Pub. Date: Apr. 25, 2013

(54) METHOD AND ARRANGEMENT OF ELECTRICAL CONDUCTORS FOR CHARGING A VEHICLE BATTERY

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/637,450

(22) PCT Filed: Mar. 24, 2011
(86) PCT No.: PCT/EP2011/001484

§ 371 Date: Jan. 8, 2013

(30) Foreign Application Priority Data
Mar. 26, 2010 (DE) 102010012884.8

(51) Int. Cl. H02J 7/00; H02J 7/02

(52) U.S. Cl. CPC H02J 7/0042; H02J 7/025
USPC 320/108; 320/137

(57) ABSTRACT

An arrangement (1) of electrical conductors (2, 2′, . . . ) for inducing an alternating current (3) which flows through this conductor arrangement (1), by means of a magnetic alternating field (4) which acts on this conductor arrangement, is used to charge a battery (5) of a vehicle (6) using the alternating current (3) which flows through the conductor arrangement (1). This conductor arrangement (1) is not connected to electrical conductors (8, 8′, . . . ) outside this conductor arrangement (1) via a low-impedance

In addition to conductive methods in which energy is transmitted via cables and connectors, inductive methods are also used to charge accumulators, particularly the batteries of electric vehicles. The present invention poses the task of contributing to further developing inductive methods and the arrangements they thereby utilize in charging vehicle batteries. This task is solved by a product or a method in accordance with any one of the independent claims.

According to the invention, an arrangement of electrical conductors is provided which is configured for inducing an alternating current which flows through said conductor arrangement by means of a magnetic alternating field acting on said conductor arrangement and charging a battery of a vehicle using the alternating current flowing through said conductor arrangement. Said conductor arrangement does not connect to electrical conductors outside of the conductor arrangement via a low-impedance connection.

According to the invention, a vehicle comprising such a conductor arrangement and having electrically conductive components situated outside of the conductor arrangement is further provided in which said electrically conductive components are interconnected in a low-impedance connection to a protective conductor disposed such that it can be grounded.

A method for charging a battery of a vehicle is additionally provided according to the invention in which an alternating current is induced in the conductor arrangement in a first step by a magnetic alternating field acting on the conductor arrangement provided for charging the vehicle battery, the arrangement not being connected to electrical conductors outside of said conductor arrangement via a low-impedance connection. A detection device continuously monitors for the absence of a low-impedance connection of the conductor arrangement to electrical conductors outside of said conductor arrangement during charging.

In conjunction with the description of the present invention, an arrangement of electrical conductors for charging a vehicle battery is to be understood as any arrangement of one or more electrical conductors which are provided to enable a magnetic alternating field acting on said conductor arrangement to induce an alternating current in the conductor arrangement such that the alternating current induced in the conductor arrangement can be used to charge the battery of a vehicle.

In this context, an alternating current flowing through such a conductor arrangement is to be understood as a current which varies over time in at least parts of the conductor arrangement, although it is particularly not necessary for it to do so periodically over the interval of time. The current can hereby change its direction over time, although it is not imperative for it to do so. The term of alternating current as used herein is also to encompass variable currents flowing in one direction which vary in amperage over time.

A magnetic alternating field in this context refers to a temporally variable magnetic field able to induce an alternating current within the meaning of the present description in such a conductor arrangement. Such temporally variable magnetic fields can be induced in an external conductor arrangement such as a transformer or an electromagnet, for example, via currents which vary over time. Magnetic alternating fields can however also be induced by means of induced permanent magnets or induced outside electrical conductor arrangements through which current flows either constantly over time or variably over time. In the present context, the term magnetic alternating field in particular also includes electromagnetic alternating fields.

To be understood by a battery in this context is any device suited to storing energy which supplies energy in electric form and from which it can also be withdrawn. This can particularly refer to galvanic cells or arrangements of galvanic cells.

A low-impedance connection of electrical conductors in this context refers to an electrically conductive connection having such a low ohmic resistance that a current flow through this connection at the currents expected in the present applicational context does not trigger any voltage drop which would impact the intended operation or the safety of the arrangement or a system in which said arrangement is used.

In accordance with a preferred embodiment of the invention, the conductor arrangement comprises a neutral point connected to electrical conductors outside of said conductor arrangement via a high-impedance connection which can in particular be grounded. In this embodiment, the neutral point and the electrical conductors outside of the conductor arrangement connected to same via the high-impedance connection stay at the same electrical potential as long as no perceptible electric current flows through the high-impedance connection. It can thereby be ensured that no dangerous contact voltages will occur between the neutral point and the electrical conductors outside of the conductor arrangement in high-impedance connection thereto as long as no electrical current able to induce such a dangerous contact voltage flows through the high-impedance connection.

In accordance with a further preferred embodiment of the invention, which can also be combined with the previous embodiment, a device for detecting a low-impedance connection between the conductor arrangement and an electrical conductor outside of said conductor arrangement is provided. Such a detecting device enables quickly identifying the occurrence or presence of a low-impedance connection of the conductor arrangement to an electrical conductor or a plurality of electrical conductors outside of the conductor arrangement. Different forms of such detecting devices are generally known.

According to a further preferred embodiment of the invention, which can also be combined with the previously cited preferred embodiments, a device to deactivate the magnetic alternating field is provided. This deactivating device is preferably triggered by a signal emitted by the detecting device should or as soon as the detecting device recognizes the occurrence or presence of a low-impedance connection of the conductor arrangement to an electrical conductor or a plurality of electrical conductors outside of the conductor arrangement. It is thus possible to deactivate the magnetic alternating field generated by an alternating current being induced in said conductor arrangement upon the occurrence or identification of a low-impedance connection of the conductor arrangement to an electrical conductor outside of said conductor arrangement. After the magnetic alternating field is powered, the induced alternating current can thus decrease so that the undesired persisting residual current between the inventive arrangement of electrical conductors and electrical conductors outside of said conductor arrangement ceases.

A vehicle in accordance with the invention preferably comprises the protective conductor configured for a low-impedance connection with electrically conductive components in the vicinity of the vehicle, in particular a ground. On accordance with a further preferred embodiment of the invention, which can also be combined with preceding embodiments, a vehicle is provided having a device for detecting a low-impedance connection of the conductor arrangement to an electrical conductor outside of said conductor arrangement. Particularly preferred is a vehicle having a device for deactivating the magnetic alternating field.

Such a device 12 for deactivating the magnetic alternating field preferably generates a signal to deactivate the magnetic alternating field which is preferably sent or transmitted to a device ET for generating the magnetic alternating field. Said signal is preferably received and analyzed by a switching device. As soon as the switching device receives the signal sent from the device 12 for deactivating the magnetic alternating field, the switching device deactivates the magnetic alternating field. This deactivating of the magnetic alternating field preferably occurs by disconnecting the energy supply for the device ET generating the magnetic alternating field.

The signal transmission from the device 12 for deactivating the magnetic alternating field, which is preferably but not imperatively mounted in or on the vehicle, to the switching device is preferably sent wirelessly, for example using light rays, infrared beams or radio waves. Signal transmission using a plurality of independent methods offers additional reliability. The signal can also be sent inductively via the conductor arrangements e, f, g and 2, 2′, 2″, preferably utilizing a carrier frequency modulated to the alternating current which is used to charge the battery. Such a modulated signal inductively generates a corresponding signal in the respective other conductor arrangement which can easily be demodulated and analyzed.

Compared to wired transmission paths, wireless transmission paths for this signal to deactivate the magnetic alternating field offer the advantage of no unwanted low-impedance connections being able to occur between the conductor arrangement (1) and electrical conductors (8, 8′. . . ) outside of said conductor arrangement (1), particularly conductors outside of the vehicle.

The device 12 for deactivating the magnetic alternating field is triggered to generate and transmit the signal to deactivate the magnetic alternating field as soon as the device 11 for detecting a low-impedance connection 7 of the conductor arrangement 1 to an electrical conductor 8, 8, . . . outside of said conductor arrangement 1 detects such a low-impedance connection. Particularly when the device 12 for deactivating the magnetic alternating field is mounted in or on the vehicle together with the device 11 for detecting a low-impedance connection 7, the control of the device 12 for deactivating the magnetic alternating field can be effected by the device 11 for detecting a low-impedance connection 7 in wired fashion. Also in cases in which the device 12 for deactivating the magnetic alternating field is mounted together with the device 11 for detecting a low-impedance connection 7 outside of the vehicle can the control of the device 12 for deactivating the magnetic alternating field be effected by the device 11 for detecting a low-impedance connection 7 in wired fashion.

In many cases, however, a wireless connection between the device 12 for deactivating the magnetic alternating field and the device 11 for detecting a low-impedance connection 7 offers safety advantages because no unwanted low-impedance connections can occur between the conductor arrangement 1 and electrical conductors 8, 8′, . . . outside of said conductor arrangement 1, particularly conductors outside of the vehicle.

With the inventive method, a neutral point of the conductor arrangement is preferably connected to electrical conductors outside of said conductor arrangement via a high-impedance connection which can in particular be grounded.

In accordance with a further preferred embodiment of the invention, which can also be combined with the preceding described examples, a method in accordance with the invention connects a protective conductor interconnecting electrically conductive components of the vehicle outside of the conductor arrangement in a low-impedance connection to electrically conductive components in the vicinity of the vehicle, a ground in particular, via a low-impedance connection. Particularly preferred hereby are embodiments of the inventive method in which the magnetic alternating field is deactivated as soon as a low-impedance connection of the conductor arrangement to electrical conductors outside of said conductor arrangement is detected during charging.

The following will draw on further preferred embodiments and the accompanying figures in describing the invention in greater detail.

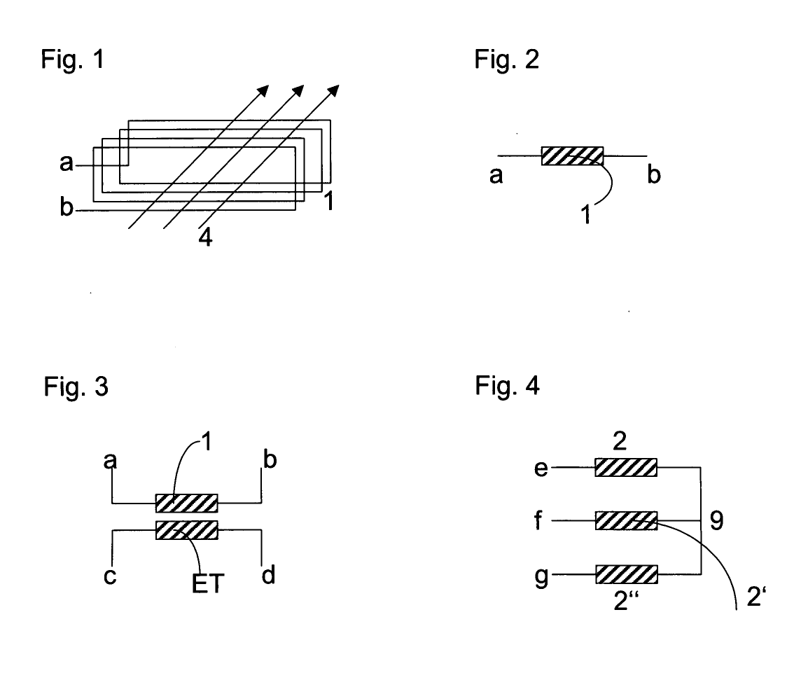

FIG. 1 thereby schematically depicts an embodiment of an inventive conductor arrangement acted upon by a magnetic alternating field.

FIG. 2 shows a symbolic depiction of the conductor arrangement depicted in FIG. 1;

FIG. 3 shows a symbolic depiction of the conductor arrangement depicted in FIG. 1 together with a further conductor arrangement providing a magnetic alternating field;

FIG. 4 schematically depicts a further embodiment of an inventive conductor arrangement comprising a star;

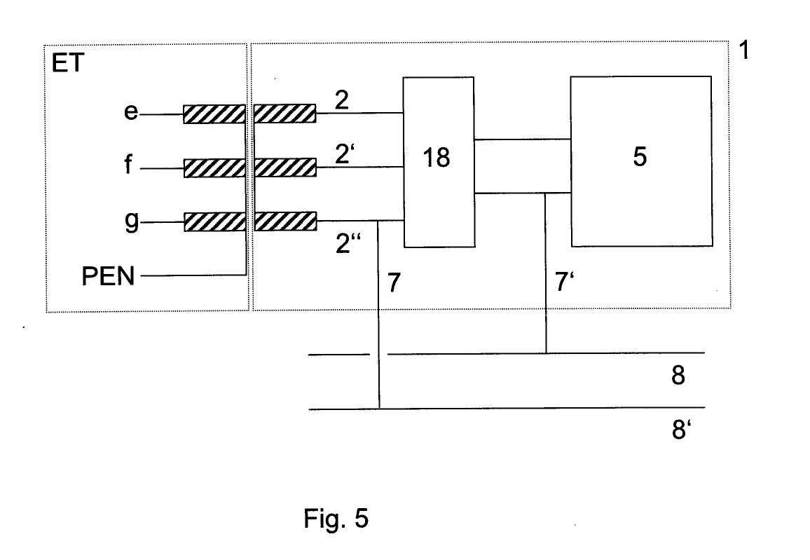

FIG. 5 schematically depicts the interaction between an inventive conductor arrangement and a further conductor arrangement providing the magnetic alternating field;

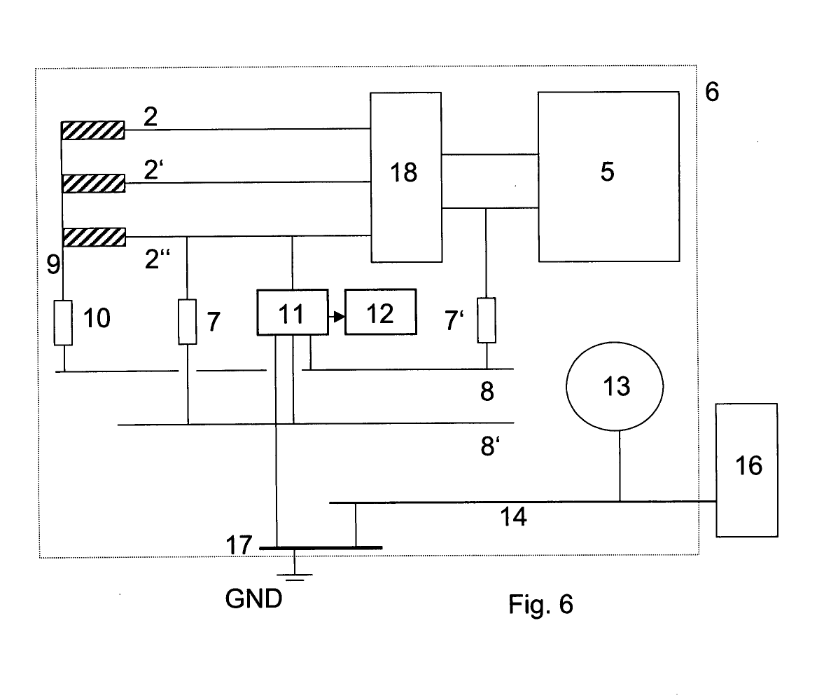

FIG. 6 schematically depicts a preferred embodiment of the invention.

As FIG. 1 shows in a first embodiment of the invention, the inventive arrangement of electrical conductors provided to charge a vehicle battery can consist for example of a coiled conductor arrangement 1 having a plurality of windings. The alternating current induced in the conductor arrangement 1 by the magnetic alternating field 4 flows through the conducting paths or windings of conductor arrangement 1 and can be tapped at points a and/or b and used to charge a vehicle battery. In the process, said induced alternating current is first periodically rectified in a manner applicable to the battery charge function. For example, FIG. 5 shows a rectifier 18 connecting to the three phases 2, 2′, 2″ of a star connection of a conductor arrangement, particularly a coiled conductor arrangement, and generating a direct voltage at the output which is supplied to a battery 5.

Depending on how the magnetic alternating field 4 is generated, the conductor arrangement 1 can thereby be of various designs and disposed in various ways relative to a field-generating conductor arrangement ET. For example, FIG. 3 shows an arrangement of the inventive conductor arrangement 1 depicted in FIG. 2 in spatial proximity to a basically similarly structured magnetic field-generating conductor arrangement ET situated outside of the vehicle with the battery to be charged. In the case shown in FIG. 3, the magnetic alternating field is generated in the coil or in the transformer ET by a single-phase alternating current supplied via points c and/or d and induces a corresponding single-phase alternating current in the conductor arrangement 1 which can be tapped at points a and/or b.

FIG. 4 shows a further example of an inventive conductor arrangement which can also be used as a field-generating conductor arrangement. This is a star-shaped interconnection of three coils 2, 2′, 2″ with infeed points e, f and g, Such star-shaped interconnections are common in conjunction with three-phase/alternating current systems. Such arrangements can serve both in generating a magnetic alternating field as well as being arrangements of electrical conductors in the sense of the invention; i.e. to charge a vehicle battery.

As FIG. 5 shows, the conductor arrangement ET generating the magnetic alternating field and the conductor arrangement 1 situated in the vehicle are configured as a transformer. The alternating current flowing in the field-generating conductor arrangement ET, in this case a three-phase current, generates a magnetic alternating field which induces a corresponding alternating current in the secondary conductor arrangements 2, 2′, 2″ of arrangement 1. Said alternating current, a three-phase current in the example shown, is rectified by the downstream rectifying arrangement 18 and the direct current generated by arrangement 18 is used at the output to charge the battery 5.

While the neutral point concentrates the magnetic alternating field of the generating arrangement into a neutral conductor PEN, the conductors 2, 2′, 2″ of arrangement 1 form the phase conductor of a so-called IT mains, the safety of which substantially depends on there being no low-impedance electrical connections 7, 7′ between the conductors of arrangement 1 and the electrical conductors 8, 8 outside of said arrangement. The low-impedance connection 7 depicted in FIG. 5 thereby corresponds to a connection of an alternating current-feeding conductor 2″ to an electrical conductor 8′ situated outside of the arrangement 1, and the low-impedance connection 7′ corresponds to a connection of a direct current-feeding conductor to a conductor 8 situated outside of the arrangement 1.

A preferred embodiment of the invention now provides for a device 11 for detecting low-impedance connections 7 of conductor arrangement 1 to an electrical conductor 8, 8′ outside of said conductor arrangement. Such detection devices 11 are generally known to the expert. Such a device 11 is also referred to as a ground leakage monitor or insulation monitoring device. It monitors the insulating condition of the IT mains, thus a non-grounded power network, for instances of falling short of a minimum insulation resistance. To this end, current is frequently measured to ground. In the event of a fault; i.e. when the insulation fault current exceeds a predefined threshold, the undercutting of the minimum insulation resistance can be detected and, as a result, further measures can be taken to ensure safety. For example, a warning signal can be generated and emitted or, as provided for in a further preferred embodiment of the invention, the magnetic alternating field supplying conductor arrangement 1 with energy can be deactivated.

The situations depicted as examples in FIGS. 5 and 6, in which the induced alternating currents are subjected to rectification so that the resulting direct currents can be used to supply a vehicle battery, are coupled with the particular difficulty that ground leakages can occur both in the alternating current subsystem as well as in the direct current subsystem of the overall vehicle power supply system. Apart from ground leakages, other low-impedance connections to electrically conductive components of the vehicle or other electrical conductors outside of arrangement 1 can also occur. This special situation of there possibly being ground leakages and other low-impedance connections both in the alternating as well as the direct current subsystems of the overall arrangement requires the use of special detection devices for detecting such low-impedance connections or ground leakages. One example of such a device for detecting stray currents and particularly ground leakages suited for such situations is described in published German application P 25 15 121 laid open on Oct. 14, 1976.

In order to exclude the occurrence of dangerous contact voltages at electrical conductors in the vehicle, particularly to ground or to conductors in the vicinity of the vehicle having a low-impedance connection to ground, and thus the resulting danger this poses to people, the invention preferably provides for equipping the device for detecting a low-impedance connection between the conductor arrangement 1 and an electrical conductor outside of said conductor arrangement with a signaling device and routing the signal to a device for deactivating the magnetic alternating field. This preferred embodiment is coupled with the advantage that upon the occurrence of a stray current, accidents can be effectively prevented by ensuring the deactivation of the magnetic alternating field providing energy to the arrangement as a whole. Deactivating the magnetic alternating field can occur for example by having the device ET for providing the magnetic alternating field comprise a switching device 12 controlled by said detection device 11. Preferably, deactivation of the magnetic alternating field occurs as soon as the detection device 11 detects that a connection 7 or 7′ between the conductors of arrangement 1 or the conductors of the arrangement on the one hand and a conductor outside of the arrangement on the other exhibits a resistance below a minimum resistance value. Said minimum resistance value can be predefined or dimensioned to the voltages utilized so as to exclude any danger to a person touching the conductor at issue.

The reference numerals specified below are used when drawing on the figures to describe the present invention:
1 arrangement of electrical conductors, conductor arrangement
2, 2′, . . . conductor of arrangement 1
3 alternating current through conductor arrangement 1
4 magnetic alternating field
5 battery
6 vehicle
7 low-impedance connection between arrangement 1 and conductors situated outside of arrangement 1
8, 8′, . . . electrical conductor outside of arrangement 1
9 neutral point
10 high-impedance connection between neutral point 9 and electrical conductors situated outside of arrangement 1
11 device for detection, detection device
12 device for deactivating the magnetic alternating field
13, 13′, . . . electrically conductive components of vehicle 6 situated outside of conductor arrangement 1
14 protective conductor
15 low-impedance connection of the protective conductor 14 to electrically conductive components 16 in the vicinity of vehicle 6
16 electrically conductive components in the vicinity of the vehicle 6
17 ground

1.-12. (canceled)

13. An arrangement of electrical conductors, comprising:
a first electrical conductor; and
a second electrical conductor, a magnetic alternating field acting on the first and second electrical conductors inducing an alternating current that flows through the arrangement of electrical conductors for charging a vehicle battery, and the first and second electrical conductors being connected to electrical conductors outside of the arrangement via a low-impedance connection.

14. The arrangement of electrical conductors as set forth in claim 13, further comprising:
a high-impedance connection; and
a neutral point connected to the electrical conductors outside of the arrangement via the high-impedance connection.

15. The arrangement of electrical conductors as set forth in claim 14, wherein:
the high-impedance connection is connected to a ground.

16. The arrangement of electrical conductors as set forth in claim 13, further including:
a detection device electrically connected between the first and second electrical conductors and the electrical conductors outside of the arrangement;
wherein the detection device detects a low-impedance connection between the first and second electrical conductors and the electrical conductors outside of the arrangement.

17. The arrangement of electrical conductors as set forth in claim 16, further including:
a deactivating device transmitting a signal based on the detection device detecting the low-impedance connection; and
a switching device deactivating the magnetic alternating field after receiving the signal from the deactivation device.

18. A vehicle, comprising:
a conductor arrangement including:
a first electrical conductor; and
a second electrical conductor, a magnetic alternating field acting on the first and second electrical conductors inducing an alternating current that flows through the conductor arrangement for charging a vehicle battery, and the first and second electrical conductors not being connected to electrical conductors outside of the conductor arrangement via a low-impedance connection;
a protective conductor connected to a ground; and
an electrically conductive component, outside of the conductor arrangement, connected to the ground via a low-impedance connection to the protective conductor.

19. The vehicle as set forth in claim 18. wherein the protective conductor is configured for a low-impedance connection with an electrically conductive component in a vicinity of the vehicle.

20. The vehicle as set forth in claim 19, wherein the electrically conductive component in the vicinity of the vehicle is the ground

21. The vehicle as set forth in claim 18, further including:
a detection device for detecting a low-impedance connection of the conductor arrangement to an electrical conductor outside of the conductor arrangement.

22. The vehicle as set forth in claim 21, further including:
a deactivating device for deactivating the magnetic alternating field.

23. The vehicle as set forth in claim 22, wherein the deactivating device transmits a signal based on the detection device detecting the low-impedance connection, the vehicle further including:
a switching device deactivating the magnetic alternating field after receiving the signal from the deactivation device.

24. A method of charging a battery of a vehicle, the method comprising:
causing a magnetic alternating field to act on a conductor arrangement of a vehicle for inducing an alternating current in the conductor arrangement; and
continuously monitoring, via a detection device, for an absence of a low-impedance connection between the conductor arrangement and an electrical conductor outside of the conductor arrangement while the battery is charging.

25. The method of charging a battery of a vehicle as set forth in claim 24, further including:
connecting a neutral point of the conductor arrangement to the electrical conductor outside of the conductor arrangement via a high-impedance connection.

26. The method of charging a battery of a vehicle as set forth in claim 24, further including:
interconnecting a protective conductor between the electrically conductive component of the vehicle outside of the conductor arrangement, which is connected to the protective conductor using a low-impedance connection, and both an electrically conductive component in a vicinity of the vehicle and a ground, both of which are connected to the protective conductor using respective low-impedance connections.

27. The method of charging a battery of a vehicle as set forth in claim 24, further including:
detecting a low-impedance connection between the conductor arrangement and the electrical conductor outside of the conductor arrangement while the battery is charging; and
deactivating the magnetic alternating field after the low-impedance connection is detected, while the battery is charging, between the conductor arrangement and the electrical conductor outside of the conductor arrangement.
